(19) United States
(12) Patent Application Publication
(10) Pub. No.: US 2006/0109989 A1
(43) Pub. Date: May 25, 2006

(54) Sound projector

(76) Inventor: Klaus Linhard, Schelklingen (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/539,843

(22) PCT Filed: Dec. 11, 2003
(86) PCT No.: PCT/EP03/14035

§ 371 Date: Jun. 20, 2005

(30) Foreign Application Priority Data
Dec. 19, 2002 (DE) 102595437

(51) Int. Cl. H04R 25/00

(52) U.S. Cl. 381/160

(57) ABSTRACT

Parametric loudspeakers that are based on a modulated ultrasound carrier signal produce strong directional patterns. This strong directional patterns require a direct transmission path from the loudspeaker to the audience. Obstacles in this path have a reflecting or absorbing effect. The invention describes a mechanical arrangement of a parametric loudspeaker with a mobile reflector. The arrangement allows tracking of the emitted sound in the direction of a moving audience. The invention provides for advantageous installation possibilities, for example in the rooflining of vehicles or as a mobile system.

### BACKGROUND OF THE INVENTION

1. Field of the Invention

The invention relates to a directional loudspeaker and to a method which is suitable for operating such a directional loudspeaker in accordance with the precharacterizing parts of patent claims 1 and 13.

2. Related Art of the Invention

Conventional systems in which the audio signal is radiated as an oscillation of air directly via single loudspeakers or else a loudspeaker array are able to achieve only relatively limited focusing of the radiated sound. By contrast, a novel method sends the audio signal not directly but rather as an alteration in the amplitude (amplitude modulation, AM) of a carrier oscillation at very high frequency (ultrasound). The underlying physical phenomenon of acoustic perception of sounds as a sequence of nonlinear properties of the air has already been recognized and examined by the physicists Helmholtz in the 19th century. The application of the physical principles for building an ultrasound/audio loudspeaker are described by Yoneyama, Fujimoto, Kawamo and Sasabe (‘The audio spotlight: An application of non-linear interaction of sound waves to a new type of loud-speaker design’, Journal of the Acoustic Society of America, 1983, pages 1532-1536).

The sound field from “parametric loudspeakers” first of all comprises only the inaudible ultrasound signal modulated with the useful signal, the audio signal. The high sound pressure of the inaudible ultrasound alters the medium of air, i.e. it becomes nonlinear. This nonlinearity results in demodulation of the audio signal which is now becoming audible. In the direction of propagation of the ultrasound, the audio sound produced is added in the correct phase.

A megaphone, which utilizes the directivity of a parametric loudspeaker system, is described in U.S. Pat. No. 6,359,990 B1. In this context, the audible signal spoken into a microphone is transmitted directionally using an annular arrangement of ultrasound signal generators.

Options for influencing the direction of radiation of a parametric loudspeaker system are also described in the specification U.S. Pat. No. 6,229,899 B1. This proposes influencing the direction of the narrowly focused ultrasound signal by either using the special electronic actuation means (electronic beam forming) or else diverting the signal using mechanical mirror arrangements. An appropriate mechanical mirror arrangement is known from the patent U.S. Pat. No. 4,791,430 A1, for example, which discloses what is known as an ultrasound antenna. An arrangement comprising a first and a second reflector is used to divert a focused ultrasound signal and to manipulate the shape of its cross section.

The specification WO 99/44757 A1 discloses an apparatus for specifically radiating ultrasound signals. Besides a combined ultrasound transmitter/receiver, the apparatus comprises a rotatably mounted reflector which can be used, among other things, to deflect the ray coming from the ultrasound source into different spatial directions. In this context, the ultrasound transmitter/receiver and the reflector are mounted separately on a common support. Since the total arrangement is not surrounded by a housing, there is the risk of the reflective face becoming soiled and of moisture penetrating the transmission/reception unit, particularly when the arrangement is used in the open air.

### SUMMARY OF THE INVENTION

It is an object of the invention to find an ultrasound reflector arrangement which can be well protected against soiling and penetrating moisture.

The invention is achieved by a directional loudspeaker and a method for operating a directional loudspeaker having the features of patent claims 1 and 13. Advantageous refinements and developments of the invention are described by the subclaims.

The novel directional loudspeaker comprises a sound source for producing highly directional sound which is formed by at least one ultrasound loudspeaker. There is also a pivotable reflector for deflecting the directional sound. Inventively, the reflector is now designed such that it can be pivoted such that its serves as mechanical protection for the directional loudspeaker's sound source. This protection is particularly against environmental influences such as soiling and moisture. In particularly advantageous fashion, the reflector thus essentially has two different orientations and functions. First, it serves to deflect the energy coming from the directional loudspeaker's sound source into a prescribable, desired direction through suitable orientation, and secondly the reflector can be folded over the sound source, so that a type of protective casing is produced which protects the ultrasound loudspeakers forming the sound source against mechanical and environmental influences.

### BRIEF DESCRIPTION OF THE DRAWINGS

The invention and advantageous refinements thereof are explained in detail below with reference to figures.

FIG. 1 shows an example of a system comprising the array baseplate and the foldable reflector.

FIG. 2 shows a possible installation variant (overhead) for the directional loudspeaker.

FIG. 3 shows a variant which comprises a second hinge for tilting the base area.

FIG. 4 shows the plan view of an exemplary arrangement of ultrasound loudspeakers.

FIG. 5 shows the side view of the basic arrangement of reflector and transducer array.

FIG. 6 shows an example of an arrangement in which the reflector has an aperture angle of 60° relative to the base area.

FIG. 7 shows an example with the aperture angle 40°.

FIG. 8 shows an arrangement in which the total system is also pivoted in addition to the reflector.

FIG. 9 shows an exemplary refinement of the directional loudspeaker which allows optimum orientation for a listener.

FIG. 10 shows a further exemplary refinement of the directional loudspeaker which allows optimum orientation.

### DETAILED DESCRIPTION OF THE INVENTION

In particularly profitable fashion, the directional loudspeaker's sound source is installed in a housing which can be sealed with the correct fit by the reflector. To this end, the reflector is particularly advantageously connected to the housing by a moving connection, which results in a type of can in which the reflector forms the lid and which can be opened and closed by changing the orientation of the reflector. In this case, the choice of moving connection is essentially dependent on the demands on the desired degree of movement for the reflector. It is thus conceivable to use a simple hinge, or else, particularly to increase the degrees of movement for the reflector, to resort to ball-and-socket joints, universal joints or cardan joints.

In particularly profitable fashion, the housing in which the sound source is installed has an essentially circular cross section. This makes it possible, by way of example, to mount the pivot joint on a raceway which is seated on the housing and which can be used to rotate the reflector along the top edge of the reflector.

The orientation of the directional loudspeaker can be set particularly advantageously if the housing itself is not mounted solidly on a support but rather is connected to it by means of a joint. This allows the spatial area to which sound can be sent directly by means of the directional loudspeaker to be extended significantly, since it becomes possible, if the orientation of the reflector with respect to the sound source remains the same, to pivot the entire arrangement comprising the reflector and the sound source. Accordingly, the inventive directional loudspeaker can be implemented particularly profitably by using a housing which comprises an outer housing and an inner housing. In this case, the directional loudspeaker's sound source is situated in the inner housing, which is connected to the reflector directly by means of a moving connection. In this context, the inner housing is advantageously mounted so that it can tilt and/or pivot with respect to the outer housing, which means that, in line with the description illustrated above, a significant extension to the surrounding area which can receive sound directly is obtained, while at the same time the outer housing protects the combined pivot arrangement against mechanical and environmental influences.

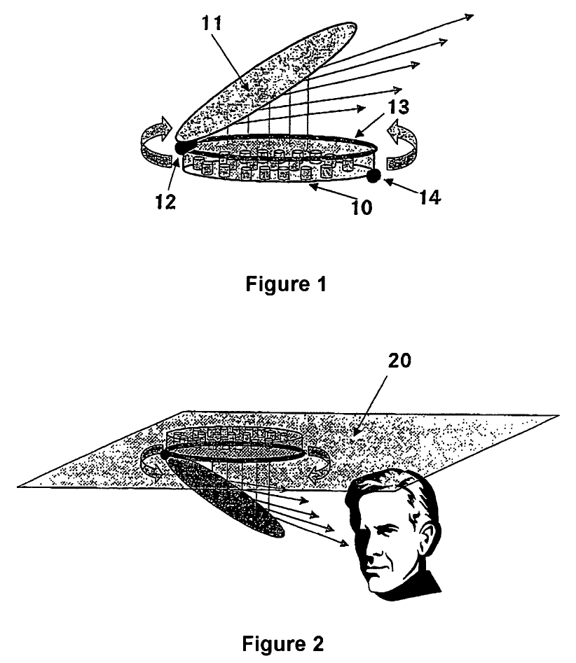

FIG. 1 shows an example of a system comprising the array baseplate (10) and the foldable reflector (11). In this context, the reflector (11) is mounted on the housing containing the sound source via a joint (12) so that it can move on a raceway (13). Such an advantageous arrangement is particularly suitable for installation on a surface, such as in a roof lining (20) in a vehicle, in line with FIG. 2. In particularly profitable fashion, the housing of the directional loudspeaker is inset into this surface. This means that the directional loudspeaker can remain “invisible” at first. To put it into operation, the reflector is opened and is preset in the range around 45°, for example. The precise lateral orientation is obtained by rotation on the raceway (13), and the height orientation is obtained through the aperture angle in the range around 45°. Whereas the joint (12) between the raceway or housing and the reflector (11) allows the reflector (11) to be pivoted essentially vertically, the raceway arranged so as to be able to move on the housing allows the reflector to be moved horizontally, rotating on a round base area.

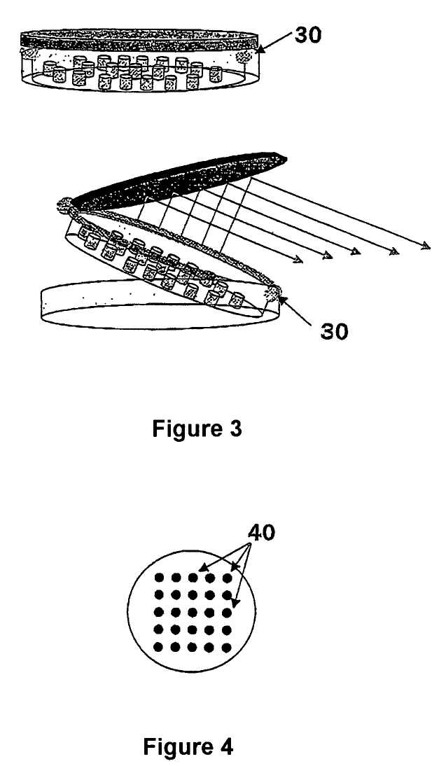

If a fixed aperture angle of 45° is sufficient, the second hinge (14, 30) for tilting the base area is not required and the individual elements can be installed either at right angles or with an appropriate inclination so as to focus. If a small range, e.g. of +10°, of the aperture angle around 45° is required, then the focusing arrangement of the ultrasound loudspeakers forming the sound source is recommended. If a large range is required for the aperture angle, then the second hinge (14, 30) is advantageous for tilting the base area, in line with FIG. 3.

Other applications are for transmitting sound in larger spaces and likewise in the open air outside of rooms and buildings. Advantageously, the system may be designed as a mobile unit. In the sealed state, the system is protected mechanically and against the influences of weathering by the reflector and a base unit. During operation, the base unit serves as a support.

FIG. 4 shows a plan view of an example of an arrangement of 25 ultrasound loudspeakers which together form the sound source of the directional loudspeaker. The 25 individual elements (40) in the form of ultrasound loudspeakers are arranged in a square, 5×5, in a round base area. In this context, the individual elements (40) may be in the form of small cylinders, for example, with the sound emergence openings at the top end thereof, said cylinders being installed in a standing position in a common base area. Such an arrangement results in the elements having a direction of radiation at right angles to the base area.

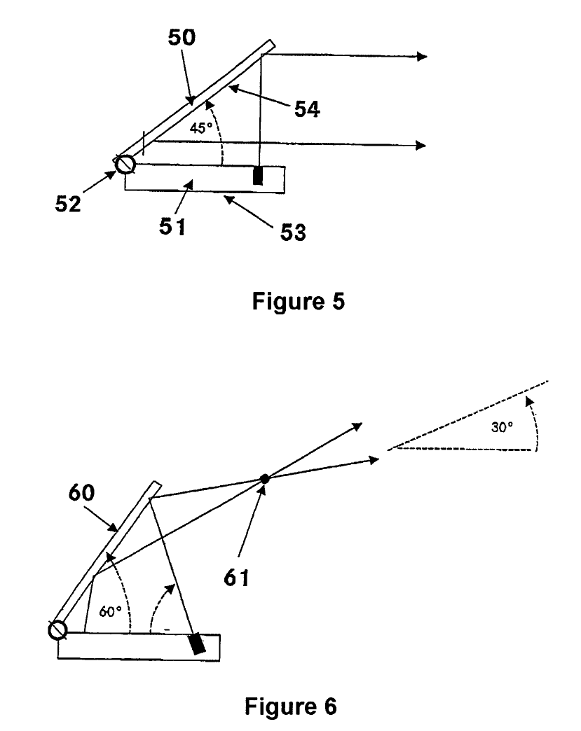

FIG. 5 shows a side view of the basic arrangement of reflector (50) and transducer array. To simplify matters, this figure shows only a single transducer in the array. The reflector is mounted on one side of the housing wall (51). The mounting used between the reflector (50) and the housing wall (51) is a hinge (52) or other joint, for example. If the reflector is arranged, as shown by way of example, at an angle of 45° relative to the array base area, then the reflected sound propagates parallel to the base area (53) of the array of sound transducers.

The angle of 45° is optimum in the sense that the reflector area (54) reflects the sound from the array completely (if we assume the highly focused radiation at right angles to the array base area). An angle of greater than 45° requires a larger reflector, and an angle of less than 45° results in partial coverage of the reflection by the base area.

If the elements in the base area are installed at an appropriate angle such that the radiation is focused, the angle of the reflector can be moved in a wider range. To simplify matters, it will be assumed here that the angle of installation of the elements in the base area is chosen such that a common focal point is obtained. The outer elements then have a greater degree of inclination than the inner ones, and the element in the center is again installed at right angles.

After the focal point, the sound is defocused and hence the directivity is also widened.

FIG. 6 shows an example of an arrangement in which the reflector (60) is at an aperture angle of 60° relative to the base area. The focal point (61) is situated after the reflection. The angle of installation of an outer element is shown with a value of −70° by way of example. If the focal point (61) were actually situated before the reflection, then the scatter of the sound field would turn out to be even greater. The choice of a focusing angle of installation for the elements in the base area thus permits an optimum aperture angle, which is variable within a certain range, around the value 45° without the drawback that the reflector would need to be enlarged or a portion of the reflection is covered. For an aperture angle of 60°, there is, regardless of focus, a resultant mean radiation angle: 2*(60°−45°)=30°.

The drawback of the focusing arrangement is defocusing (scatter). If the listener is in the direct proximity of the arrangement in the sound ray, for example, then a certain amount of scatter is entirely tolerable, since the listener himself again acts as a reflector.

The choices of aperture angle and installation angle for focusing are dependent on one another in that with a large aperture angle it is also necessary to use a large inclination (installation angle) if the reflector size is not intended to be increased.

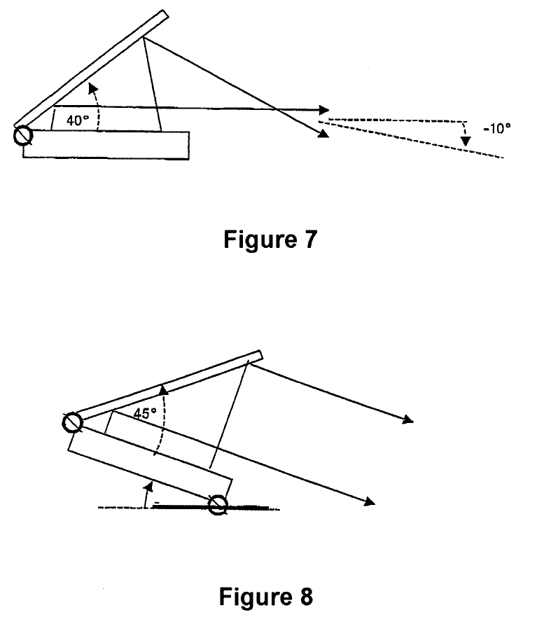

FIG. 7 shows an example with the aperture angle 40° and the resultant mean radiation angle: 2*(45°−40°)=−10°.

The choice of aperture angle, below 45°, and the installation angle of the outer elements in the base area is not totally free, since the reflection may be covered by the base area in this case or no further reflection may take place. In this instance, the exact geometric illustration will be dispensed with. By way of example, the magnitudes obtained as suitable angle of inclination for the outer elements are: 80, 70 and 60° for the respective aperture angle of 40, 35 and 30°.

If the listener is at a greater distance from the array, the focusing radiation no longer makes sense because the defocusing losses a large portion of the directivity. It is more advantageous to tilt the basic system as shown in the illustration in FIG. 8 and to maintain the optimum aperture angle of 45°.

By way of example, a plurality of single transducers, i.e. an array system, have been used for the transducer system in the base area. Instead of the individual transducers, the ultrasound transmitter may comprise just one transducer. Ordinary transducers radiate the sound with a high level of directivity in one direction, the sound ray widening somewhat with distance. On the basis of the prior art, an individual transducer may also be designed to have a focusing effect, so that it is of no significance to the total system described whether a single transducer or a plurality of transducers are used.

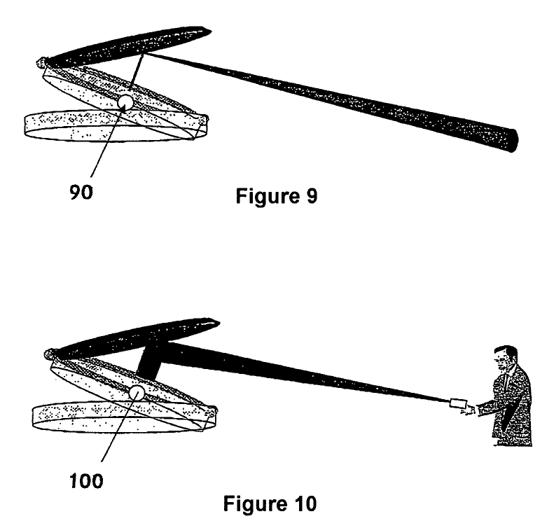

The high level of directivity of the system requires orientation to the listener. A simple means of assistance is indicated by way of example in FIG. 9. In this context, the center of the directional loudspeaker's base area contains an element (90) which radiates a focused beam of light in the direction of the sound propagation. The impingement of the point of light allows the destination, the point at which sound is desired, to be set. In this case, the setting would be made manually. Advantageously, the element (90) is a laser, which emits a focused beam of light which can easily be perceived on the illuminated people or objects.

Automatic setting to the object which is intended to receive the sound could be done, by way of example, by an opto-electronic image evaluation unit which evaluates the reflection of a laser beam, for example. This image evaluation unit could then provide the control signals for rotating and tilting the system. Instead of complex image evaluation, control by means of an infrared sensor is also possible, said sensor then following the object with the most intense radiated heat.

A further option is obtained if the object which is intended to receive sound emits a signal, such as a point of light or a radio signal. A receiver connected to a position-finding device can use this signal to determine the location of the object and can orient the reflector system thereto. If the object which is intended to receive sound emits a point of light, for example from a laser, then an appropriate receiver (100), as indicated in FIG. 10, can be installed directly in the base area of the directional loudspeaker, in order to evaluate the light reflected by the reflector. In this context, the maximum incidence of light is obtained with a system which has the correct acoustic orientation relative to the light source.

Particularly advantageously, the novel directional loudspeaker can be used to send sound to people in motor vehicles, since its housing is ideal for being integrated in embedded fashion in internal devices of the vehicle. On the other hand, the novel directional loudspeaker affords profitable opportunities for use outside of vehicles or buildings too, particularly on account of the opportunities for protecting the sound transducers against environmental influences. Directional loudspeakers designed in accordance with the invention can be integrated relatively inconspicuously on the roof of vehicles, for example, and can thus provide sound specifically for the surrounding area of the vehicle in active operation. By way of example, it would thus be possible on a picnic to provide sound specifically for the limited space in the area of the person or picnic spot without bothering the people in the surrounding area.

1-21. (canceled)

22. A directional loudspeaker, comprising
a sound source for producing highly directional sound which is formed by at least one ultrasound loudspeaker,
a pivotable reflector being provided for deflecting the directional sound,
wherein the at least one ultrasound loudspeaker is located in a housing,
wherein the relector is connected to the housing, and
wherein the housing is mounted on a support so as to be able to pivot and tilt relative to said support.

23. The directional loudspeaker as claimed in claim 22, wherein
the housing comprises an outer housing and an inner housing,
the reflector is moveably connected to the inner housing via a linkage, and
the inner housing is mounted so that it can tilt and/or pivot with respect to the outer housing.

24. The directional loudspeaker as claimed in claim 22, wherein the reflector is connected to and mounted on the wall of the housing such that it can be moved along the top of the wall.

25. A directional loudspeaker, comprising
a sound source for producing highly directional sound which is formed by at least one ultrasound loudspeaker,
a pivotable reflector being provided for deflecting the directional sound,
wherein the at least one ultrasound loudspeaker is located in a housing,
wherein the relector is connected to the housing, and
wherein the reflector is connected to and mounted on the wall of the housing such that it can be moved along the top of the wall.

26. The directional loudspeaker as claimed in claim 22, wherein the reflector is moveably connected to the housing by a joint.

27. The directional loudspeaker as claimed in claim 22, wherein the wall of the housing has a circular cross section.

28. The directional loudspeaker as claimed in claim 22, wherein the reflector is pivoted such that it serves as mechanical protection for the directional loudspeaker's sound source, particularly against environmental influences such as soiling and moisture.

29. The directional loudspeaker as claimed in claim 22, wherein the housing, in which the ultrasound loudspeaker is situated, can be sealed by the reflector.

30. The directional loudspeaker as claimed in claim 22, wherein the directional loudspeaker's sound source is formed by a plurality of ultrasound loudspeakers which are arranged to form an array, the individual ultrasound loudspeakers being arranged so as to be inclined at an angle relative to one another such that their collective radiation is focused.

31. The directional loudspeaker as claimed in claim 22, wherein the directional loudspeaker is connected to a means for locating people or objects who/which are intended to receive the directional ultrasound signal.

32. The directional loudspeaker as claimed in claim 31, wherein the means for locating people or objects is situated in or on the housing of the directional loudspeaker.

33. The directional loudspeaker as claimed in claim 31, wherein the means for locating people or objects is able to locate a laser or a radio signal using its emitted light signal or radio signal.

34. The directional loudspeaker as claimed in claim 33, wherein the means for locating people or objects is arranged such that it receives the beam of light from the laser via the latter's deflection on the directional loudspeaker's reflector.

35. The directional loudspeaker as claimed in claim 1 wherein a means is provided which can be used to orient the directional loudspeaker specifically to people or objects who/which are intended to receive sound.

36. The directional loudspeaker as claimed in claim 35, wherein the directional loudspeaker comprises, as additional means, a laser which is arranged in the directional loudspeaker's housing and illuminates the people or objects by means of beam deflection on the directional loudspeaker's reflector.

37. A method for operating a directional loudspeaker, comprising:
emitting highly directional sound from a sound source via at least one ultrasound loudspeaker, and
deflecting the emitted sound by means of a reflector swivel-mounted on the housing, wherein
for the directional orientation of the sound the housing or the inner part of the housing with which the reflector is connected is tilted or pivoted relative to the base of the housing or its supplemental housing outer part.

38. A method for operating a directional loudspeaker, comprising:
emitting highly directional sound from a sound source via at least one ultrasound loudspeaker, and
deflecting the emitted sound by means of a reflector swivel-mounted on the housing, wherein
for the directional orientation of the sound the reflector is moved via a bearing along upper wall of the housing.

39. The method as claimed in claim 37, wherein sound source is mechanically protected by pivoting the reflector such that it closes it off particularly from environmental influences such as soiling and moisture.

40. The method as claimed in claim 39, wherein the people or objects, to whom/which the directional ultrasound is emitted, are located,
and consequently the reflector is oriented suitably for the purpose of radiating to this locality.

41. The method as claimed in claim 40, wherein of people or object location is effected on the basis of a laser beam or a radio signal, which is sent by a laser or radio, situated at the location which is to be located, to a laser light receiver associated with the directional loudspeaker, said receiver being able to infer the location of the light source from the received light signal.

42. The method as claimed in claim 37, wherein to assist the specific orientation of the directional loudspeaker the people or objects who/which are situated in the current direction of the main ray from the directional loudspeaker are specifically illuminated.

43. The method as claimed in claim 42, wherein the specific illumination is effected using a laser.
